(19) United States
(12) Patent Application Publication
(10) Pub. No.: US 2025/0358902 A1
(43) Pub. Date: Nov. 20, 2025

(54) SYSTEMS AND METHODS FOR CONTROLLING A HEATER BASED ON A DIFFERENTIAL CURRENT

(71) Applicant: WATLOW ELECTRIC MANUFACTURING COMPANY, St. Louis, MO (US)

(72) Inventor: Jacob LINDLEY, Nashville, TN (US)

(73) Assignee: WATLOW ELECTRIC MANUFACTURING COMPANY, St. Louis, MO (US)

(21) Appl. No.: 19/291,830

(22) Filed: Aug. 6, 2025

Related U.S. Application Data
(63) Continuation of application No. PCT/US2024/014688, filed on Feb. 7, 2024.
(60) Provisional application No. 63/443,837, filed on Feb. 7, 2023.

(51) Int. Cl. H05B 1/02; H05B 3/00

(52) U.S. Cl. CPC H05B 1/0208; H05B 3/0019

(57) ABSTRACT

A control system includes a controller that is configured to determine a differential current of a heater based on a difference between a power conductor current of the heater and a neutral conductor current of the heater, determine whether the differential current of the heater is greater than a threshold differential current, and selectively perform a corrective action in response to the differential current being greater than the threshold differential current.

### CROSS-REFERENCE TO RELATED APPLICATIONS

This application is a continuation of International Application No. PCT/US2024/014688, filed on Feb. 7, 2024, which claims priority to U.S. provisional application No. 63/443,837 filed on Feb. 7, 2023. The disclosures of the above applications are incorporated herein by their reference.

### FIELD

The present disclosure relates to systems and methods for controlling a heater based on a differential current.

### BACKGROUND

The statements in this section merely provide background information related to the present disclosure and may not constitute prior art.

Thermal systems are employed in a variety of environments, such as a semiconductor processing environment, a combustion exhaust environment, reaction vessels, heat exchangers, an industrial dryer and separator of a water treatment apparatus, a fluid flow environment, among other types of environments. The thermal systems may include one or more heaters for heating a load and a control system for controlling the operation of the heater. The heaters can be any of a variety of types, including by way of example, layered heaters formed by a layered process (e.g., thick film, thin film, thermal spray, sol-gel), metal-sheathed heaters (e.g., tubular heaters), and cartridge heaters, among others. Additionally or alternatively, the heaters may be low-voltage heaters operating at about 600V and below or medium-voltage heaters operating at voltage levels at about 600V to 4 kV.

Moisture ingress can occur in many types of heaters and is especially problematic for heaters that have hygroscopic insulation material. To inhibit or remove this moisture, the control system and the heater may collectively perform a “bake-out” process in which the heater receives electrical power to remove or inhibit the moisture.

In one example, the bake-out process employs time-based controls that may result in an inaccurate time period for performing the bake-out process. That is, when the bake-out time period is too short, moisture remains in the heater. As such, the heater cannot be operated at full voltage, and accordingly, the bake-out process may need to be repeated to remove the moisture. Furthermore, when the bake-out time period is too long, the thermal system may operate at high temperatures for a longer time than needed, thereby inhibiting the efficiency of the thermal system. These and other issues related to the removal of moisture from heaters are addressed by the present disclosure.

### SUMMARY

This section provides a general summary of the disclosure and is not a comprehensive disclosure of its full scope or all of its features.

The present disclosure provides a control system comprising a controller configured to determine a differential current of a heater based on a difference between a power conductor current of the heater and a neutral conductor current of the heater, determine whether the differential current of the heater is greater than a threshold differential current, and selectively perform a corrective action in response to the differential current being greater than the threshold differential current.

The following paragraph includes variations of the control system of the above paragraph, and the variations may be implemented individually or in any combination while remaining within the scope of the present disclosure.

In one form, the control system includes a first sensor configured to measure the power conductor current and a second sensor configured to measure the neutral conductor current; the control system includes a transformer configured to measure the power conductor current and the neutral conductor current and output a voltage value that is indicative of the differential current; in response to the differential current being greater than the threshold current, the controller is configured to determine an operational power level based on the power conductor current, an operation setpoint, and an operation control routine, determine a bake-out power level based on the differential current, a differential current threshold, and a moisture control routine, and determine whether the operational power level is less than the bake-out power level; the controller is configured to perform the corrective action by: providing, as a power output level, the operational power level to the heater in response to the operational power level being less than the bake-out power level, and providing, as the power output level, the bake-out power level to the heater in response to the operational power level being greater than the bake-out power level; the control system includes a power regulator circuit electrically coupled to the heater, where the power regulator circuit is configured to provide the power output level to the heater; the power regulator circuit includes a power switch operable by the controller to provide the power output level to the heater; the operation control routine is a proportional-integral-derivative control routine, a model predictive control routine, or a combination thereof; the moisture control routine is a proportional-integral-derivative control routine, a model predictive control routine, or a combination thereof; and/or the operation setpoint is one of a temperature setpoint and an electrical characteristic setpoint.

The present disclosure provides a thermal system comprising a heater and a control system. The control system includes a controller configured to determine a differential current of a heater based on a difference between a power conductor current of the heater and a neutral conductor current of the heater, determine whether the differential current of the heater is greater than a threshold differential current, and selectively perform a corrective action in response to the differential current being greater than the threshold differential current. The heater is electrically coupled to the controller, and the heater comprises a resistive heating element for heating a load. In variations of the present disclosure, the heater is selected from the group consisting of a layered heater, a tubular heater, a cartridge heater, a polymer heater, and a flexible heater.

The present disclosure also provides a control system for controlling a heater. The control system includes comprising a power regulator circuit configured to provide an adjustable power to the heater. The control system includes a controller configured to obtain a power conductor current of the heater and a neutral conductor current of the heater, determine a differential current based on a difference between the power conductor current and the neutral conductor current, determine whether the differential current of the heater is greater than a threshold differential current, and selectively perform a corrective action in response to the differential current being greater than the threshold differential current.

The following paragraph includes variations of the control system of the above paragraph, and the variations may be implemented individually or in any combination while remaining within the scope of the present disclosure.

In one form, the control system includes a first sensor configured to measure the power conductor current and a second sensor configured to measure the neutral conductor current; the control system includes a transformer configured to measure the power conductor current and the neutral conductor current and output a voltage value that is indicative of the differential current; the power regulator circuit includes a power switch operable by the controller to provide the power output level to the heater; in response to the differential current being greater than the threshold current, the controller is configured to determine an operational power level based on the power conductor current, an operation setpoint, and an operation control routine, determine a bake-out power level based on the differential current, a differential current threshold, and a moisture control routine, and determine whether the operational power level is less than the bake-out power level; the controller is configured to perform the corrective action by: providing, as a power output level, the operational power level to the heater in response to the operational power level being less than the bake-out power level, and providing, as the power output level, the bake-out power level to the heater in response to the operational power level being greater than the bake-out power level; the operation control routine is a proportional-integral-derivative control routine, a model predictive control routine, or a combination thereof; the moisture control routine is a proportional-integral-derivative control routine, a model predictive control routine, or a combination thereof; and/or the operation setpoint is one of a temperature setpoint and an electrical characteristic setpoint.

The present disclosure also provides a thermal system comprising a heater and a control system. The includes comprising a power regulator circuit configured to provide an adjustable power to the heater. The control system includes a controller configured to obtain a power conductor current of the heater and a neutral conductor current of the heater, determine a differential current based on a difference between the power conductor current and the neutral conductor current, determine whether the differential current of the heater is greater than a threshold differential current, and selectively perform a corrective action in response to the differential current being greater than the threshold differential current. The heater is electrically coupled to the controller, and the heater comprises a resistive heating element for heating a load. In variations of the present disclosure, the heater is selected from the group consisting of a layered heater, a tubular heater, a cartridge heater, a polymer heater, and a flexible heater.

The present disclosure provides a method for controlling a heater that includes determining a differential current of a heater based on a difference between a power conductor current of the heater and a neutral conductor current of the heater, determining whether the differential current of the heater is greater than a threshold differential current, and selectively performing a corrective action in response to the differential current being greater than the threshold differential current.

The present disclosure also provides another method for controlling a heater that includes obtaining a power conductor current of the heater and a neutral conductor current of the heater, determining a differential current of a heater based on a difference between the power conductor current and the neutral conductor current, determining whether the differential current of the heater is greater than a threshold differential current, and selectively performing a corrective action in response to the differential current being greater than the threshold differential current.

The present disclosure provides an additional method for controlling a heater that includes determining a differential current of the heater based on a difference between a power conductor current of the heater and a neutral conductor current of the heater, determining an operational power level based on the power conductor current, an operation setpoint, and a power control routine, determining a bake-out power level based on the differential current, a differential current threshold, and a moisture control routine, determining whether the operational power level is less than the bake-out power level, providing, as a power output level, the operational power level to the heater in response to the operational power level being less than the bake-out power level, and providing, as the power output level, the bake-out power level to the heater in response to the operational power level being greater than the bake-out power level.

The present disclosure provides yet another method for controlling a heater that includes determining a differential current of the heater based on a difference between a power conductor current of the heater and a neutral conductor current of the heater, determining an operational power level based on the power conductor current, an operation setpoint, and an operation control routine, determining a bake-out power level based on the differential current, a differential current threshold, and a moisture control routine, determining whether the operational power level is less than the bake-out power level, controlling the power regulator circuit to provide, as a power output level, the operational power level to the heater in response to the operational power level being less than the bake-out power level, and controlling the power regulator circuit to provide, as the power output level, the bake-out power level to the heater in response to the operational power level being greater than the bake-out power level.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of an example thermal system including a heater and a control system in accordance with the teachings of the present disclosure;

FIG. 2 is a block diagram of another example thermal system including a heater and a control system in accordance with the teachings of the present disclosure;

FIG. 3 is a block diagram of yet another example thermal system including a heater and a control system in accordance with the teachings of the present disclosure;

FIG. 4 is a flowchart of an example routine for controlling a heater in accordance with the teachings of the present disclosure;

FIG. 5 is a flowchart of another example routine for controlling a heater in accordance with the teachings of the present disclosure;

FIG. 6 is a flowchart of an example routine for performing a corrective action in accordance with the teachings of the present disclosure; and

FIG. 7 is a flowchart of another example routine for performing a corrective action in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

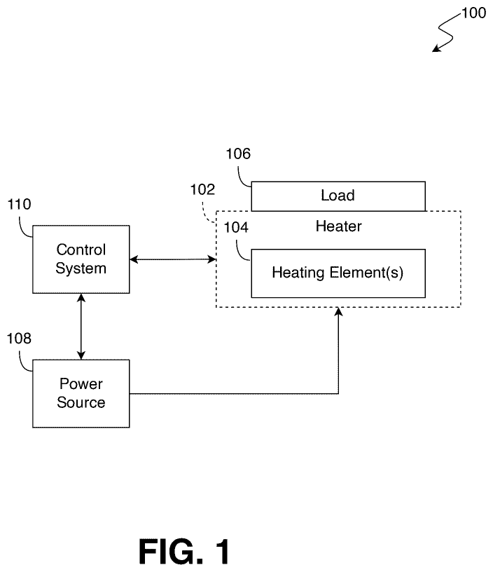

Referring to FIG. 1, an example thermal system 100 is shown and generally includes a heater 102 having one or more resistive heating elements 104, a load 106, a power source 108, and a control system 110. The thermal system 100 may be employed in various environments, including, but not limited to, a semiconductor processing environment, a combustion exhaust environment, reaction vessels, heat exchangers, an industrial dryer and separator of a water treatment apparatus, a fluid flow environment, among other types of environments employing thermal systems.

In one form, the heater 102 may be a layered heater having a dielectric layer, a resistive layer defining the one or more resistive heating elements 104, and a protective layer disposed on a substrate. The one or more resistive heating elements 104 defined by the resistive layer may be “two-wire” heating elements that operate as a sensor for measuring an average temperature of the resistive heating element based on a resistance of the resistive heating element as well as a heating element to heat the load 106. Thus, only two wires are used rather than four wires with a discrete sensor. More particularly, such a two-wire heater is disclosed in U.S. Pat. No. 7,196,295 titled “TWO-WIRE LAYERED HEATER SYSTEM,” which is commonly owned with the present application and the contents of which are incorporated herein by reference in its entirety. In a two-wire thermal system, the thermal system 100 is an adaptive thermal system that merges heater designs with controls that incorporate power, resistance, voltage, and current in a customizable feedback control system that limits one or more of these parameters (i.e., power, resistance, voltage, and current) while controlling another.

It should be understood that the number of layers of the layered heater (as the heater 102) and the configuration of the layers are merely examples and that a variety of combinations of layers applied to each other without a separate substrate are within the teachings of the present disclosure. Such variations are disclosed, by way of example, in U.S. Pat. No. 7,132,628 titled “VARIABLE WATT DENSITY LAYERED HEATER” and U.S. Pat. No. 8,680,443 titled “COMBINED MATERIAL LAYERING TECHNOLOGIES FOR ELECTRIC HEATERS,” which are commonly assigned with the present application and the contents of which are incorporated herein by reference in their entirety. In these examples, the layers are formed through the application or accumulation of a material to a substrate or another layer using processes associated with thick film, thin film, thermal spraying, or sol-gel, among others.

While the heater 102 is described as a layered heater, the teachings of the present disclosure are applicable to other types of heaters, such as tubular heaters, cartridge heaters, polymer heaters, and flexible heaters, among others. As an example, the heater 102 may be a cartridge heater that includes the resistive heating elements 104 (e.g., a metal wire) disposed around a nonconductive portion, a sheath, a dielectric material (e.g., MgO) disposed between the resistive heating element and the sheath, and two pins. In one form, the pins are connected to lead wires (not shown) and extend through the nonconductive portion and connect to the ends of the resistive heating element for supplying power to the resistive heating element. More particularly, such a cartridge heater is disclosed in U.S. patent application Ser. No. 16/568,757 titled “SYSTEM AND METHOD FOR CLOSED-LOOP BAKE-OUT CONTROL,” which is commonly owned with the present application and the contents of which are incorporated herein by reference in its entirety.

In one form, the power source 108 is an alternating current (AC) or direct current (DC) power source that is configured to apply or provide an adjustable input voltage to the heater 102. In one form, the control system 110 is an adaptive thermal system configured to monitor at least one of current, voltage, and power delivered to the resistive heating element to determine the resistance and temperature of the resistive heating element. More particularly, such adaptive thermal systems and controllers are disclosed in U.S. Pat. No. 10,690,705 titled “POWER CONVERTER FOR A THERMAL SYSTEM” and U.S. Pat. No. 10,908,195 titled “SYSTEM AND METHOD FOR CONTROLLING POWER TO A HEATER,” which are commonly owned with the present application and the contents of which are incorporated herein by reference in its entirety.

In one form, the control system 110 is configured to control the heater 102 during a primary operation, where the heater 102 heats the load 106 in accordance with one or more predefined performance parameters. In one form, the primary operation of the heater 102 includes different operational states, such as a warm-up state, steady-state, and/or a power-down state. Each operational state may include different performance parameters, such as a power setpoint, for the given state. Example operational states are disclosed in U.S. Pat. No. 10,908,195, which is commonly owned with the present application and the contents of which are incorporated herein by reference in its entirety.

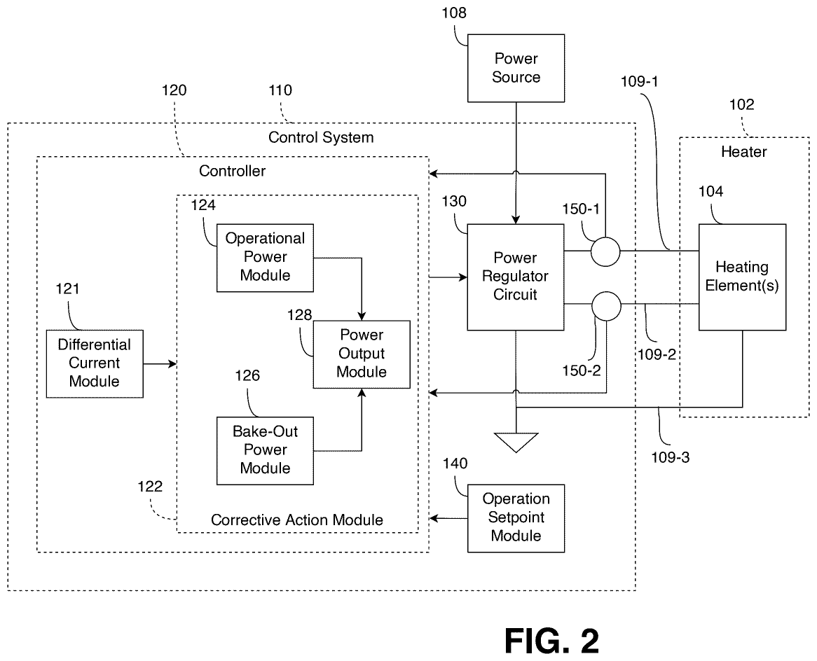

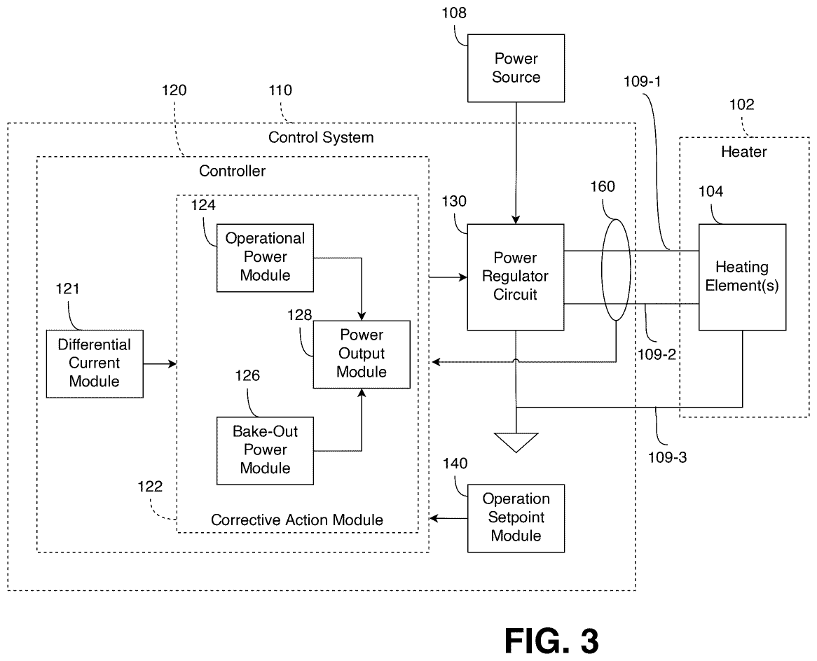

During the primary operation, moisture may accumulate within a dielectric layer and/or a protective layer of the layered heater (as the heater 102). In another example, moisture may begin to accumulate between the ends of the resistive heating elements 104 and the lead wires of the cartridge heater (as the heater 102). Moisture within the heater 102 creates alternative current paths, and the current flowing through these alternative paths are commonly referred to as “leakage current.” In some forms, the heater 102 draws more total current when there is moisture than when the heater 102 is dry and substantially free of moisture. Accordingly, the control system 110 monitors the moisture within the heater 102 during the primary operation and interrupts the primary operation to perform a bake-out process and remove the moisture when a measured leakage current exceeds a leakage current threshold. Additional details regarding the bake-out process and the control system 110 are provided below with reference to FIGS. 2-3.

Referring to FIGS. 2-3, the control system 110 includes a controller 120, a power regulator circuit 130, and an operation setpoint module 140. In one form, the components of the controller 120 and the operation setpoint module 140 are communicably coupled using a wired communication protocol and/or a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). It should be readily understood that any one of the components of the controller 120 and the operation setpoint module 140 can be provided at the same location or distributed at different locations (e.g., via one or more edge computing devices) and communicably coupled accordingly.

In one form, the controller 120 includes a differential current module 121 and a corrective action module 122. In one form, the differential current module 121 is configured to obtain a power conductor current of the heater 102 and a neutral conductor current of the heater 102. As used herein, “power conductor current” refers to a current value associated with a power conductor 109-1 of the heater 102, and “neutral conductor current” refers to a current value associated with a neutral conductor 109-2 of the heater 102. It should be understood that the differential current module 121 may obtain current data from a ground conductor 109-3 of the heater 102 in other forms.

As an example and as shown in FIG. 2, the corrective action module 122 obtains the power conductor current from a first current sensor 150-1 proximate to (e.g., adjacent and/or near) the power conductor 109-1 and the neutral conductor current from a second current sensor 150-2 proximate to the neutral conductor 109-2. The first and second current sensors 150-1, 150-2 may be collectively referred to hereinafter as “the current sensors 150.” In one form, the current sensors 150 are discrete current sensors and/or integrated circuit current sensors that output signals indicative of the current associated with the respective conductor. As another example and as shown in FIG. 3, the corrective action module 122 is coupled to a transformer 160 that is proximate to the power conductor 109-1 and the neutral conductor 109-2 and that measures the power conductor current and the neutral conductor current. The number of the current sensors 150 and/or the transformers 160 may vary based on the type of heater 102 and should not be limited to the examples described herein.

It should be understood that the control system 110 may not include one or more of the current sensors 150 and the transformer 160 when the heater 102 is provided by the “two-wire” heater described herein that measures current based on the resistance changes of the resistive heating element 104. That is, the two-wire heater merges heater designs with controls that incorporate power, resistance, voltage, and current in a customizable feedback control system that limits one or more these parameters (i.e., power, resistance, voltage, current) while controlling another. For example, by calculating the resistance of the resistive heating element 104 and knowing the voltage being applied, the power conductor current is determined without the use of a discrete or integrated circuit current sensor. According, the two-wire system may operate as the current sensors.

In one form, the differential current module 121 determines a differential current of the heater 102 based on a difference between the power conductor current and the neutral conductor current and determines whether the differential current is greater than a threshold differential current. As used herein, “differential current” refers to a magnitude difference between the power conductor current and the neutral conductor current. It should be understood that the differential current may be based on a difference between the power conductor current and the ground conductor current and/or the neutral conductor current and the ground conductor current in other variations. In one form, the threshold differential current is a preset value that corresponds to a permitted or acceptable amount of leakage current and/or moisture (e.g., 30 mA). As an example and referring to FIG. 2, the differential current module 121 may determine the current differential by determining a magnitude difference between the power conductor current measured by the first current sensor 150-1 and the neutral conductor current measured by the second current sensor 150-2. As another example and referring to FIG. 3, the differential current module 121 may correlate the voltage value output by the transformer 160, which is indicative of the differential current, to a lookup table that correlates voltage values to predetermined differential currents.

In one variation, the power conductor 109-1, the neutral conductor 109-2, and the ground conductor 109-3 of the heater 102 are arranged in a delta wiring configuration as opposed to the wye configuration shown in FIGS. 2-3 when, for example, the heater 102 is provided by a circulation heater. Accordingly, the differential current may be based on a magnitude difference between the power conductor current and the ground conductor current, the power conductor current and the ground conductor current, or the neutral conductor current and the ground conductor current in this variation.

In one form, the corrective action module 122 is configured to selectively perform a corrective action in response to the differential current being greater than the threshold differential current and includes an operational power module 124, a bake-out power module 126, and a power output module 128. The operational power module 124 determines an operational power level for the heater 102 based on the power conductor current, the operation setpoint, and a power control routine. In one form, the operational setpoint is a baseline parameter that is based on an input received for the operation state being performed and/or a predefined value associated with the operation state. In one form, the operational setpoint is received from the operation setpoint module 140, which may include one or more human machine interfaces (HMIs), such as an input device (e.g., a keyboard, mouse, among other input devices), a graphical user interface (e.g., a touchscreen display or other type of display device), and/or other types of HMIs configured to receive inputs from an operator. As an example, the operational setpoint includes a temperature setpoint and/or an electrical characteristic setpoint (e.g., a voltage setpoint, a current setpoint, a power setpoint, among other types of electrical characteristic setpoints).

In one form, the power control routine is a proportional-integral-derivative (PID) control routine that calculates the operational power level to be applied to the heater 102 to have the actual power approach the power setpoint. As an example, in one form, the power control routine calculates the actual power being supplied to the heater 102 based on the power conductor current and an input voltage applied to the heater 102. The power control routine determines the difference between the actual power being applied to the power setpoint and determines the required level of power needed (i.e., the operational power level) for inhibiting the difference between the actual power of the heater 102 and the power setpoint. Accordingly, the PID control routine is a closed-loop control routine that adjusts the power applied to the heater 102 to approach the power setpoint. It should be understood that the power control routine may be employed by other types of closed-loop control routines, such as a model predictive control routine, and the power control routine is not limited to the example described herein.

The bake-out power module 126 determines a bake-out power level based on the differential current, a differential current threshold, and a moisture control routine. In one form, the moisture control routine is a PID control routine that calculates the bake-out power level for reducing the leakage current such that the differential current is less than or equal to the differential current threshold. As an example, the moisture control routine determines the difference between the differential current and the differential current threshold and calculates the level of power needed (i.e., the bake-out power level) to reduce the differential current such that it is less than the differential current threshold. Accordingly, the PID control routine is a closed-loop control routine that adjusts the power applied to the heater 102 to quickly bake out the moisture in the heater 102 (i.e., reduce the leakage current). It should be understood that the moisture control routine may be employed by other types of closed-loop control routines, such as a model predictive control routine, and the moisture control routine is not limited to the example described herein.

The power output module 128 determines whether the operational power level is less than the bake-out power level and selects a power level to be applied to the one or more resistive heating elements 104 (i.e., a power output level) based on the determination. As an example, the power output module 128 selects the operational power level as the power output level in response to the operational power level being less than the bake-out power level. As another example, the power output module 128 selects the bake-out power level as the power output level in response to the operational power level being greater than the bake-out power level.

In one form, the power regulator circuit 130 is electrically coupled to the heater 102 and is configured to provide an adjustable power to the heater 102. That is, the power regulator circuit 130 is configured to provide the power output level to the one or more resistive heating elements 104. As an example, the power regulator circuit 130 provides the operational power level to the heater 102 (as the power output level) in response to the operational power level being less than the bake-out power level. As another example, the power regulator circuit 130 provides the bake-out power level to the heater 102 (as the power output level) in response to the operational power level being greater than the bake-out power level.

To perform the functionality described herein, the power regulator circuit 130 may include thyristors, voltage dividers, voltage converters, transformers, power switches, and/or other suitable electronic components. As an example, the power regulator circuit 130 employs low phase angle switching or zero crossing switching to adjust the voltage from the power source 108. In another example, the power source 108 may include a high voltage source for the operational power level and a low voltage source for the bake-out power level, and the power regulator circuit 130 is configured to switch between the two sources based on a control signal from the power output module 128. In yet another example, the power regulator circuit 130 is configured to provide both high and low currents by way of a variable transformer. In another example, the power regulator circuit 130 is a power converter including a rectifier and a buck converter, and such a power converter is described in U.S. Pat. No. 10,690,705, which is commonly owned with the present application and the contents of which are incorporated herein by reference in its entirety. It should be readily understood that the controller 120 is configured to control the power regulator circuit 130 and may include different circuitry and non-transitory computer-readable instructions based on the type of power regulator circuit 130.

As described herein, the controller 120 controls the power applied to the heater 102 to heat the load 106 during a given operation state. During the primary operation, the controller 120 monitors the differential current within the heater 102 (e.g., the leakage current) and determines a bake-out power level when the differential current is greater than the threshold differential current. Furthermore, the controller 120 determines the operational power level during the primary operation and instructs the power regulator circuit 130 to apply the lower power level from among the bake-out power level and the operational power level. That is, the controller 120 inhibits the leakage current by applying a lower but sufficient voltage to the heater 102 to remove the moisture and inhibit damage to the heater 102 and/or other components of the thermal system 100.

Accordingly, the controller 120 decreases the bake-out time by employing only the time and power needed to decrease the leakage current and remove the moisture from the heater 102. Specifically, in lieu of discrete time periods and set power amounts for removing the moisture, the controller 120 employs closed-loop control routines for inhibiting the amount of time and power employed for reducing the leakage current and removing moisture from or drying out the heater 102.

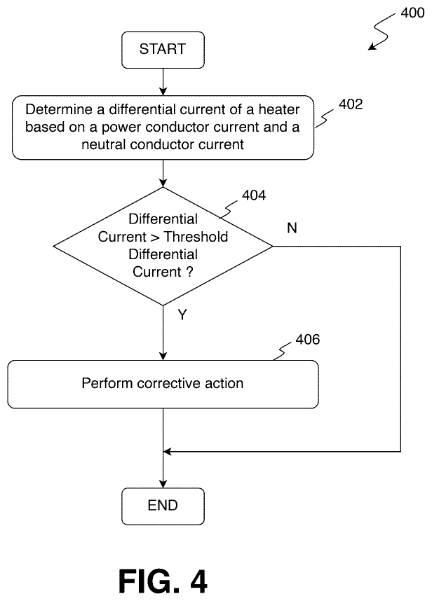

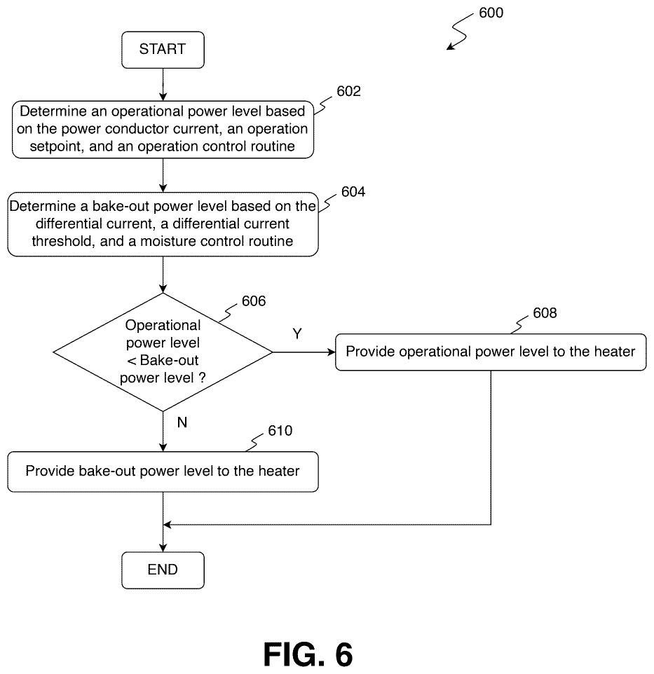

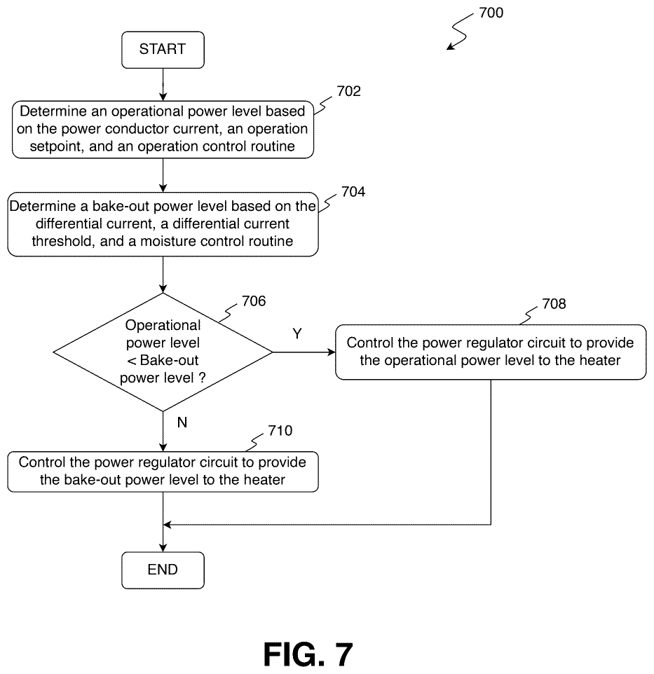

Referring to FIG. 4, a flowchart illustrating an example routine 400 for controlling a heater 102 is shown. At 402, the controller 120 determines a differential current of the heater 102 based on a difference between a power conductor current of the heater 102 and a neutral conductor current of the heater 102. At 404, the controller 120 determines whether the differential current of the heater 102 is greater than a threshold differential current. If so, the routine 400 proceeds to 406, where the controller 120 performs a corrective action and then ends. Otherwise, the routine 400 ends when the differential current of the heater 102 is less than a threshold differential current. Example routines for performing the corrective action at step 406 are described below in further detail with reference to FIGS. 6-7.

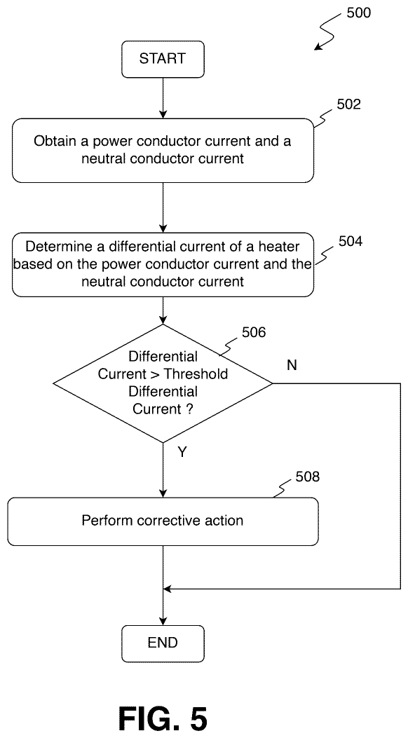

Referring to FIG. 5, a flowchart illustrating an example routine 500 for controlling a heater 102 is shown. At 502, the controller 120 obtains a power conductor current and a neutral conductor current of the heater 102. At 504, the controller 120 determines a differential current of the heater 102 based on a difference between the power conductor current and the neutral conductor current. At 506, the controller 120 determines whether the differential current of the heater 102 is greater than a threshold differential current. If so, the routine 500 proceeds to 508, where the controller 120 performs a corrective action and then ends. Otherwise, the routine 500 ends when the differential current of the heater 102 is less than a threshold differential current. Example routines for performing the corrective action at step 508 are described below in further detail with reference to FIGS. 6-7.

Referring to FIG. 6, a flowchart illustrating an example routine 600 for performing the corrective action described above at steps 406, 508 of FIGS. 4-5, respectively, is shown. At 602, the control system 110 determines an operational power level based on the power conductor current, an operation setpoint, and a power control routine. At 604, the control system 110 determines a bake-out power level based on the differential current, a differential current threshold, and a moisture control routine. At 606, the control system 110 determines whether the operational power level is less than the bake-out power level. If so, the routine 600 proceeds to 608, where the control system 110 provides, as the power output level, the operational power level to the heater 102. Otherwise, the routine 600 proceeds to 610, where the control system 110 provides, as the power output level, the bake-out power level to the heater 102.

Referring to FIG. 7, a flowchart illustrating an example routine 700 for performing the corrective action described above at steps 406, 508 of FIGS. 4-5, respectively, is shown. At 702, the controller 120 determines an operational power level based on the power conductor current, an operation setpoint, and a power control routine. At 704, the controller 120 determines a bake-out power level based on the differential current, a differential current threshold, and a moisture control routine. At 706, the controller 120 determines whether the operational power level is less than the bake-out power level. If so, the routine 700 proceeds to 708, where the controller 120 controls the power regulator circuit 130 to provide, as the power output level, the operational power level to the heater 102. Otherwise, the routine 700 proceeds to 710, where the controller 120 controls the power regulator circuit 130 to provide, as the power output level, the bake-out power level to the heater 102.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A control system comprising:
a controller configured to:
determine a differential current of a heater based on a difference between a power conductor current of the heater and a neutral conductor current of the heater;
determine whether the differential current of the heater is greater than a threshold differential current; and
selectively perform a corrective action in response to the differential current being greater than the threshold differential current.

2. The control system of claim 1 further comprising:
a first sensor configured to measure the power conductor current; and
a second sensor configured to measure the neutral conductor current.

3. The control system of claim 1 further comprising a transformer configured to:
measure the power conductor current and the neutral conductor current; and
output a voltage value that is indicative of the differential current.

4. The control system of claim 1, wherein in response to the differential current being greater than the threshold current, the controller is configured to:
determine an operational power level based on the power conductor current, an operation setpoint, and an operation control routine;
determine a bake-out power level based on the differential current, a differential current threshold, and a moisture control routine; and
determine whether the operational power level is less than the bake-out power level.

5. The control system of claim 4, wherein the controller is configured to perform the corrective action by:
providing, as a power output level, the operational power level to the heater in response to the operational power level being less than the bake-out power level; and
providing, as the power output level, the bake-out power level to the heater in response to the operational power level being greater than the bake-out power level.

6. The control system of claim 5 further comprising a power regulator circuit electrically coupled to the heater, wherein the power regulator circuit is configured to provide the power output level to the heater.

7. The control system of claim 6, wherein the power regulator circuit includes a power switch operable by the controller to provide the power output level to the heater.

8. The control system of claim 4, wherein the operation control routine is a proportional-integral-derivative control routine, a model predictive control routine, or a combination thereof.

9. The control system of claim 4, wherein the moisture control routine is a proportional-integral-derivative control routine, a model predictive control routine, or a combination thereof.

10. The control system of claim 4, wherein the operation setpoint is one of a temperature setpoint and an electrical characteristic setpoint.

11. A thermal system comprising:
the control system of claim 1; and
a heater, wherein the heater is electrically coupled to the controller, and wherein the heater comprises a heating element for heating a load.

12. The thermal system of claim 11, wherein the heater is selected from the group consisting of a layered heater, a tubular heater, a cartridge heater, a polymer heater, and a flexible heater.

13. A control system for controlling a heater, the control system comprising:
a power regulator circuit configured to provide an adjustable power to the heater; and
a controller configured to:
obtain a power conductor current of the heater and a neutral conductor current of the heater;
determine a differential current based on a difference between the power conductor current and the neutral conductor current;
determine whether the differential current of the heater is greater than a threshold differential current; and
selectively perform a corrective action in response to the differential current being greater than the threshold differential current.

14. The control system of claim 13 further comprising:
a first sensor configured to measure the power conductor current; and
a second sensor configured to measure the neutral conductor current.

15. The control system of claim 13 further comprising a transformer configured to:
measure the power conductor current and the neutral conductor current; and
output a voltage value that is indicative of the differential current.

16. The control system of claim 13, wherein in response to the differential current being greater than the threshold current, the controller is configured to:
determine an operational power level based on the power conductor current, an operation setpoint, and an operation control routine;
determine a bake-out power level based on the differential current, a differential current threshold, and a moisture control routine; and
determine whether the operational power level is less than the bake-out power level.

17. The control system of claim 16, wherein the controller is configured to perform the corrective action by:
providing, as a power output level, the operational power level to the heater in response to the operational power level being less than the bake-out power level; and
providing, as the power output level, the bake-out power level to the heater in response to the operational power level being greater than the bake-out power level.

18. The control system of claim 17, wherein the power regulator circuit includes a power switch operable by the controller to provide the power output level to the heater.

19. The control system of claim 16, wherein the operation control routine is a proportional-integral-derivative control routine, a model predictive control routine, or a combination thereof.

20. The control system of claim 16, wherein the moisture control routine is a proportional-integral-derivative control routine, a model predictive control routine, or a combination thereof.

21. The control system of claim 16, wherein the operation setpoint is one of a temperature setpoint and an electrical characteristic setpoint.

22. A thermal system comprising:
the control system of claim 13; and
the heater, wherein the heater is electrically coupled to the controller, and wherein the heater comprises a heating element for heating a load.

23. The thermal system of claim 22, wherein the heater is selected from the group consisting of a layered heater, a tubular heater, a cartridge heater, a polymer heater, and a flexible heater.

24. A method for controlling a heater comprising:
determining a differential current of a heater based on a difference between a power conductor current of the heater and a neutral conductor current of the heater;
determining whether the differential current of the heater is greater than a threshold differential current; and
selectively performing a corrective action in response to the differential current being greater than the threshold differential current.

25. A method for controlling a heater comprising:
obtaining a power conductor current of the heater and a neutral conductor current of the heater;
determining a differential current of a heater based on a difference between the power conductor current and the neutral conductor current;
determining whether the differential current of the heater is greater than a threshold differential current; and
selectively performing a corrective action in response to the differential current being greater than the threshold differential current.

26. A method for controlling a heater comprising:
determining a differential current of the heater based on a difference between a power conductor current of the heater and a neutral conductor current of the heater;
determining an operational power level based on the power conductor current, an operation setpoint, and a power control routine;
determining a bake-out power level based on the differential current, a differential current threshold, and a moisture control routine;
determining whether the operational power level is less than the bake-out power level;
providing, as a power output level, the operational power level to the heater in response to the operational power level being less than the bake-out power level; and
providing, as the power output level, the bake-out power level to the heater in response to the operational power level being greater than the bake-out power level.

27. A method for controlling a heater comprising:
determining a differential current of the heater based on a difference between a power conductor current of the heater and a neutral conductor current of the heater;
determining an operational power level based on the power conductor current, an operation setpoint, and an operation control routine;
determining a bake-out power level based on the differential current, a differential current threshold, and a moisture control routine;
determining whether the operational power level is less than the bake-out power level;
controlling a power regulator circuit to provide, as a power output level, the operational power level to the heater in response to the operational power level being less than the bake-out power level; and
controlling the power regulator circuit to provide, as the power output level, the bake-out power level to the heater in response to the operational power level being greater than the bake-out power level.
